(19) United States
(12) Patent Application Publication
(10) Pub. No.: US 2020/0107220 A1
(43) Pub. Date: Apr. 2, 2020

(54) Methods and Apparatuses for Managing Compression of Information in a Wireless Network

(71) Applicant: TELEFONAKTIEBOLAGET LM ERICSSON (PUBL), Stockholm (SE)

(72) Inventors: Ritesh Shreevastav, Upplands Väsby (SE); Mattias BERGSTRÖM, SOLLENTUNA (SE); Agnes RENSFELT, Bromma (SE)

(21) Appl. No.: 16/497,886

(22) PCT Filed: Mar. 22, 2018
(86) PCT No.: PCT/SE2018/050297

§ 371 Date: Sep. 26, 2019

Related U.S. Application Data
(60) Provisional application No. 62/479,364, filed on Mar. 31, 2017.

(51) Int. Cl. H04W 28/06; H03M 7/30; H04W 12/00; H04W 28/02; H04W 8/24

(52) U.S. Cl. CPC H04W 28/06; H03M 7/6094; H04W 8/24; H04W 12/0013; H04W 28/0284; H03M 7/607

(57) ABSTRACT

A method performed by a network node (110) is described herein. The method is for managing compression of information to be transmitted by a transmitting device (130) 5 in a set of packets. The network node (110) determines (304) whether or not to apply a first compression algorithm to the information comprised in the set of packets. The determining (304) is based on at least one of: i) a compression efficiency of the first compression algorithm applied to a first information comprised in a first set of packets, and ii) a computational complexity of the first algorithm. The information is a second 10 information and the set of packets is a second set of packets. Each of the first and the second set of packets comprise at least one packet. The network node (110) then initiates (305) providing, based on a result of the determination, an indication of the result to the transmitting device (130).

### TECHNICAL FIELD

The present disclosure relates generally to a network and methods performed thereby for managing compression of information to be transmitted by a transmitting device in a set of packets. The present disclosure also relates generally to a transmitting device and methods performed thereby for managing compression of information to be transmitted by the transmitting device in a set of packets.

### BACKGROUND

Communication devices within a wireless communications network may be e.g., stations (STAs), User Equipments (UEs), mobile terminals, wireless devices, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Communication devices may also be network nodes, or Transmission Points (TP). The wireless communications network covers a geographical area which may be divided into cell areas, each cell area being served by an access node such as a Base Station (BS), e.g., a Radio Base Station (RBS), which sometimes may be referred to as e.g., evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The wireless communications network may also be considered a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eN Bs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station. 3GPP LTE radio access standard has been written in order to support high bitrates and low latency both for uplink and downlink traffic. All data transmission is in LTE controlled by the radio base station.

A study item on Uplink Data Compression (UDC) in LTE, RP-162541 “Study on UL data compression in LTE” has been brought in Rel-14 of LTE. The motivation for this study is that the air interface may get congested and hence it may, in some scenarios, be beneficial to compress the data before it may be sent over the air interface. Compression of information, e.g., data, may be understood as a procedure wherein a data sequence may be reduced in size by applying a compression algorithm. A compression algorithm may be understood as a procedure which may e.g., find patterns in the data sequence and replace them with a short hand form of the pattern. For example, if the data sequence “AAABBCCCCC” should be compressed, a compression algorithm may compress the sequence to “3A2B5C”, where a number preceding an alphabetic letter may indicate how many times the alphabetic letter is repeated. It may be noted that this is just a simplified non-limiting example of a compression algorithm but other algorithms may be built on the same principle.

One proposed solution for data compression in e.g., LTE, is that in the Packet Data Convergence Protocol (PDCP) layer of LTE, as described in the 3GPP TS 36.323, v.14.1.0, “Evolved Universal Terrestrial Radio Access (E-UTRA); Packet Data Convergence Protocol (PDCP) specification”, the possibility to compress Service Data Units (SDUs) at the transmitter is introduced. The receiver may, upon reception of a packet, decompress the data and forward the result to higher layers. It may be understood that in other systems than LTE, compression may be performed in a layer similar to the PDCP layer in LTE.

A compression efficiency, that is, an efficiency of a compression, may be determined for compression, e.g., as a compression ratio. This may be calculated, for example, by the following formula:

1−(size of the compressed data/size of the original data sequence).

In the example above, where AAABBCCCCC, which is 10 letters long, is compressed to 3A2B5C, which is 6 letters long, the ratio may be calculated as: 1−(6/10)=0.4. A higher compression ratio or compression efficiency may be understood to mean that the size of the compressed data is smaller.

In order for compression as described above to provide meaningful gains, some conditions may need to be met. One such condition may be that that the data carried in the PDCP SDU is not already compressed. Another condition may be that the data is not encrypted, since encrypted data may in general look like white noise, in the sense that there are few patterns which may be found in the data, and without patterns in the data, compression in general results in less compression gain.

In LTE, Radio Resource Control (RRC) LTE signaling may be extended to support the new compression schemes, as illustrated in FIG. 1. As shown in the example of FIG. 1, an eNB 11 may, at 12 provide a configuration to a UE 13, in this example, an RRC Connection Reconfiguration, comprising a configuration for Uplink Data Compression (UDC), which indicates to the UE 13 that UDC should be enabled. As a response to this configuration, the UE 13 may, at 14, respond to the eNB 11 with a confirmation message indicating that the UE 13 has applied the configuration. This confirmation is in the form of an RRC Connection Reconfiguration Complete message.

One use case of the UDC may be to target Hyper Text Transfer Protocol (HTTP) headers which may be part of payload. For web browsing, when a UE has requested to visit any un-encrypted webpage, a subsequent client request with the GET command may include lot of repetitive information. Thus, this may be targeted to be compressed. However, if the webpage is encrypted, it may not be possible to achieve compression gain. A GET command may be understood as a message used to request a server to send certain information, e.g., an image, text-file, HTML-file, etc. . . . . Furthermore, existing methods for compression of information may result in waste of processing power, unnecessary memory usage, or both.

### SUMMARY

It is an object of embodiments herein to improve the handling of compression of information in a communications network.

According to a first aspect of embodiments herein, the object is achieved by a method performed by a network node. The method is for managing compression of information to be transmitted by a transmitting device in a set of packets. The network node and the transmitting device operate in a wireless communications network. The network node determines whether or not to apply a first compression algorithm to information comprised in a set of packets to be transmitted by the transmitting device. The determining is based on at least one of: i) a compression efficiency of the first compression algorithm applied to a first information comprised in a first set of packets, and ii) a computational complexity of the first algorithm. The information is a second information and the set of packets is a second set of packets. Each of the first set of packets and the second set of packets comprises at least one packet. The network node then initiates providing, based on a result of the determination of whether or not to apply the first compression algorithm, an indication of the result of the determination to the transmitting device.

According to a second aspect of embodiments herein, the object is achieved by a method performed by the transmitting device. The method is for managing compression of information to be transmitted by the transmitting device in the set of packets. The transmitting device operates in the wireless communications network. The transmitting device obtains, from the network node operating in the wireless communications network, the indication of the result of the determination of whether or not to apply the first compression algorithm to the information comprised in the set of packets to be transmitted by the transmitting device. The obtaining of the indication is based on at least one of: i) the compression efficiency of the first compression algorithm applied to the first information comprised in the first set of packets, and ii) the computational complexity of the first algorithm. The information is the second information and the set of packets is the second set of packets. Each of the first set of packets and the second set of packets comprises at least one packet. The transmitting device also initiates applying the first compression algorithm on the second information, based on the received indication.

According to a third aspect of embodiments herein, the object is achieved by the network node configured to manage the compression of the information configured to be transmitted by the transmitting device in the set of packets. The network node and the transmitting device are configured to operate in the wireless communications network. The network node is further configured to determine whether or not to apply the first compression algorithm to the information configured to be comprised in the set of packets configured to be transmitted by the transmitting device. To determine is configured to be based on at least one of: i) the compression efficiency of the first compression algorithm configured to be applied to the first information configured to be comprised in the first set of packets, and ii) the computational complexity of the first algorithm. The information is the second information and the set of packets is the second set of packets. Each of the first set of packets and the second set of packets is configured to comprise at least one packet. The network node is further configured to initiate providing, based on the result of the determination of whether or not to apply the first compression algorithm, the indication of the result of the determination to the transmitting device.

According to a fourth aspect of embodiments herein, the object is achieved by the transmitting device, configured to manage the compression of the information configured to be transmitted by the transmitting device in the set of packets. The transmitting device is configured to operate in the wireless communications network. The transmitting device is further configured to obtain, from the network node configured to operate in the wireless communications network, the indication of the result of the determination of whether or not to apply the first compression algorithm to the information comprised in the set of packets configured to be transmitted by the transmitting device. To obtain the indication is configured to be based on at least one of: i) the compression efficiency of the first compression algorithm configured to be applied to the first information configured to be comprised in the first set of packets, and ii) the computational complexity of the first algorithm. The information is the second information and the set of packets are the second set of packets. Each of the first set of packets and the second set of packets is configured to comprise at least one packet. The transmitting device is further configured to initiate applying the first compression algorithm on the second information, based on the indication configured to be received.

By the network node determining whether or not to apply the first compression algorithm based on at least one of the compression efficiency and the computational complexity of the first algorithm, the compression algorithm may be enabled in a dynamic fashion. Therefore, unnecessary signalling between the network node and the transmitting device with regards of compression of information, e.g., data, RRC reconfiguration bits etc . . . , may be avoided. Accordingly, embodiments herein enable to reduce air interface load and control the wastage of processing capacity between the network node and the transmitting device, e.g., a UE. Furthermore, it may be avoided that compression is enabled in cases where there is no significant gain, and hence it may be avoided that the transmitter attempts to compress data which would anyway not benefit from compression.

### BRIEF DESCRIPTION OF THE DRAWINGS

Examples of embodiments herein are described in more detail with reference to the accompanying drawings, and according to the following description.

FIG. 1 is a schematic diagram illustrating RRC Signaling in LTE, according to existing methods.

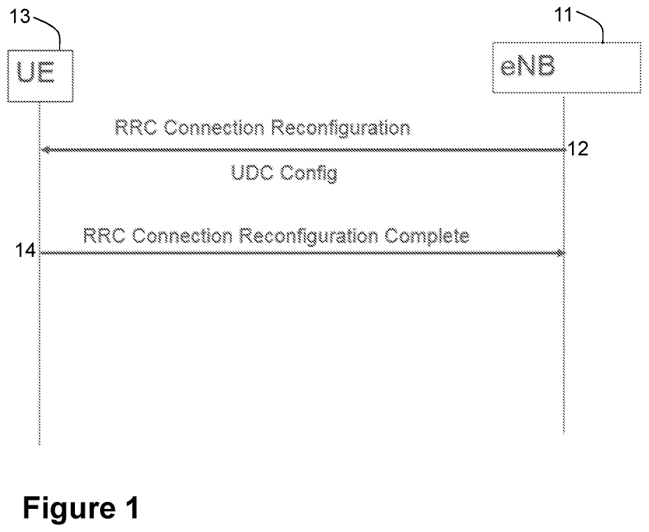

FIG. 2 is a schematic diagram illustrating a wireless communications network, according to embodiments herein.

FIG. 3 is a flowchart depicting a method in a network node, according to embodiments herein.

FIG. 4 is a flowchart depicting embodiments of a method in a transmitting device, according to embodiments herein.

FIG. 5 is a schematic diagram illustrating a potential structure showing placement of a compression algorithm, according to embodiments herein.

FIG. 6 is a schematic block diagram illustrating embodiments of a network node, according to embodiments herein.

FIG. 7 is a schematic block diagram illustrating embodiments of a transmitting device, according to embodiments herein.

### DETAILED DESCRIPTION

As part of the development of embodiments herein, a problem will first be identified and discussed.

While compression of data has the potential to reduce the amount of data sent over the air, and may hence increase capacity, etc., it does cost in terms of processing and memory use to perform compression. As discussed above, in some situations, compression may not provide any gains, and to apply compression in such cases may result in waste of processing power and/or unnecessary memory usage. This may be the case, e.g., when a webpage is encrypted

In order to address this problem, several embodiments are comprised herein. As a summarized overview, embodiments herein may be understood to relate to a method for enabling compression algorithms, in a dynamic fashion. Particular embodiments herein may therefore relate to providing an opportunistic compression mechanism to reduce air interface load and control the wastage of processing capacity in UE and eNB. As a summarized overview, embodiments herein may be understood to relate to an eNB taking information about the data packets into consideration, and estimate compression gain to evaluate if compression should be activated.

Embodiments will now be described more fully hereinafter with reference to the accompanying drawings, in which examples are shown. In this section, the embodiments herein will be illustrated in more detail by a number of exemplary embodiments. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from 3GPP LTE has been used in this disclosure to exemplify the embodiments herein, this should not be seen as limiting the scope of the embodiments herein to only the aforementioned system. Other wireless systems, including NR, WCDMA, WiMax, WLAN, UMB and GSM, may also benefit from exploiting the ideas covered within this disclosure.

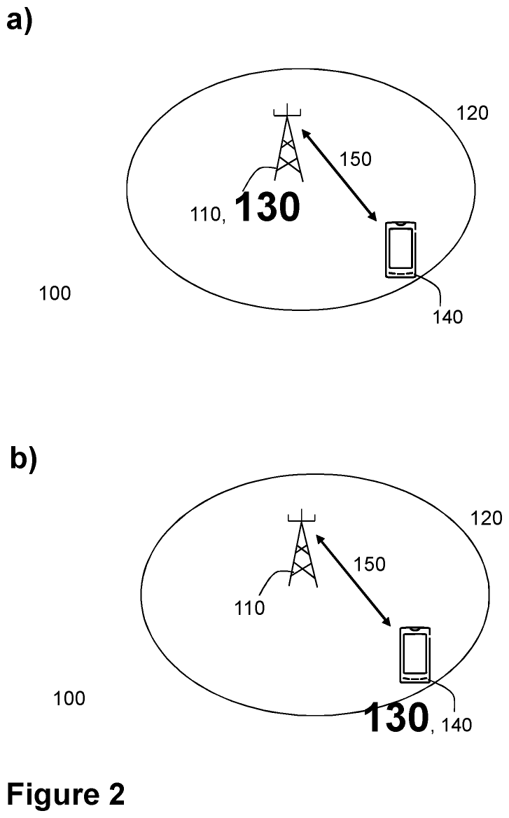

FIG. 2 depicts an example of a wireless communications network 100, sometimes also referred to as a wireless communications system, cellular radio system, or cellular network, in which embodiments herein may be implemented. The wireless communications network 100 may typically be a Long-Term Evolution (LTE) network, e.g. LTE Frequency Division Duplex (FDD), LTE Time Division Duplex (TDD), LTE Half-Duplex Frequency Division Duplex (HD-FDD), or LTE operating in an unlicensed band. The wireless communications network 100 may support other technologies such as, for example, New Radio (NR), Wideband Code Division Multiplexing Access (VVCDMA), Universal Terrestrial Radio Access (UTRA) TDD, Global System for Mobile communications (GSM) network, Enhanced Data for GSM Evolution (EDGE) network, GSM/EDGE Radio Access Network (GERAN) network, Ultra-Mobile Broadband (UMB), network comprising of any combination of Radio Access Technologies (RATs) such as e.g., Multi-Standard Radio (MSR) base stations, multi-RAT base stations etc., any 3rd Generation Partnership Project (3GPP) cellular network, Wireless Local Area Network (WLAN), e.g., WFi networks, Worldwide Interoperability for Microwave Access (WMax), Category M (CAT-M), Narrow Band Internet of Things (NB-IoT), or any cellular network or system. Thus, although terminology from 3GPP LTE may be used in this disclosure to exemplify embodiments herein, this should not be seen as limiting the scope of the embodiments herein to only the aforementioned system.

The wireless communications network 100 comprises a plurality of network nodes, whereof a network node 110 is depicted in FIG. 2, as described later. The network node 110 may be a transmission point such as a radio base station, for example an eNB, an eNodeB, or a Home Node B, a Home eNode B, a gNB, or any other network node capable of serving a wireless device, such as a user equipment or a machine type communication device, in the wireless communications network 100. The wireless communications network 100 covers a geographical area which may be divided into cell areas, wherein each cell area may be served by a network node, although, one network node may serve one or several cells. In the non-limiting example depicted in FIG. 2, the network node 110 serves a cell 120. In examples wherein the wireless communications network 100 may be considered a non-cellular system, the network node 110 may serve receiving nodes, such as wireless devices, with serving beams. The network node 110 may be of different classes, such as, e.g., macro eNodeB, home eNodeB or pico base station, based on transmission power and thereby also cell size. Typically, the wireless communications network 100 may comprise more cells similar to the cell 120, served by their respective network node. This is not depicted in FIG. 2 for the sake of simplicity. The network node 110 may support one or several communication technologies, and its name may depend on the technology and terminology used. In LTE or in a 5G Network, the network node 110, which may be referred to as eNodeBs or even eNBs, may be directly connected to one or more core networks, which are not depicted in FIG. 2.

The wireless communications network 100 comprises also a transmitting device 130. In some embodiments, the transmitting device 130 may be a network node such as network node 110 just described. In fact, the transmitting device 130, in some particular embodiments, may be the network node 110, as depicted in panel a) of FIG. 2. In other embodiments, the transmitting device 130 may be a wireless device such as wireless device 140 described below, as depicted in panel b) of FIG. 2.

A plurality of wireless devices is located in the wireless communication network 100, whereof a wireless device 140, is depicted in the non-limiting example of FIG. 2. The wireless device 140 comprised in the wireless communications network 100 may be a wireless communication device such as a UE, or a 5G UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) device, device equipped with a wireless interface, such as a printer or a file storage device, modem, or any other radio network unit capable of communicating over a wired or radio link in a communications system. The wireless device 140 comprised in the wireless communications network 100 is enabled to communicate wirelessly in the wireless communications network 100. The communication may be performed e.g., via a RAN and possibly the one or more core networks, which may be comprised within the wireless communications network 100.

The network node 110 may be a serving network node of the wireless device 140. The wireless device 140 may be configured to communicate within the wireless communications network 100 with the network node 110 over a link 150, e.g., a radio link.

In general, the usage of “first” and/or “second” herein may be understood to be an arbitrary way to denote different entities, and may be understood to not confer a cumulative or chronological character to the nouns they modify.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are: a) embodiments related to a network node, such as the network node 110; and b) embodiments related to a transmitting device, such as the transmitting device 130, e.g., a UE, or an eNB. Embodiments herein may be described with some non-limiting examples. In the following description any reference to a/the eNB, or a/the network may be understood to relate to the network node 110; any reference to a/the terminal or a/the UE may be understood to relate to the transmitting device 130.

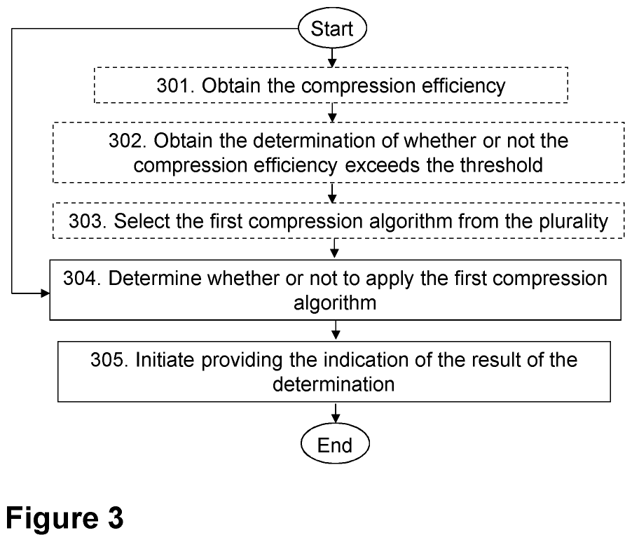

Embodiments of method performed by the network node 110, will now be described with reference to the flowchart depicted in FIG. 3. The method may be understood to be for managing compression of information to be transmitted by the transmitting device 130 in a set of packets. The network node 110 and the transmitting device 130 operate in the wireless communications network 100.

In some embodiments all the actions may be performed. In some embodiments, one or more actions may be performed. One or more embodiments may be combined, where applicable. All possible combinations are not described to simplify the description. In FIG. 3, optional actions are indicated with dashed lines. Some actions may be performed in a different order than that shown in FIG. 3.

Action 301

In order to manage the compression of the information to be transmitted by the transmitting device 130 in the set of packets, in this Action 301, the network node 110 may obtain the compression efficiency of the first algorithm applied to the first information in the first set of packets. A packet may be, e.g., an SDU. The information may be understood as data e.g., a header, and/or payload, in for example, Internet Protocol traffic, such as web browsing, video streaming, File Transfer Protocol (FTP) uploads or downloads, etc. . . . .

Obtaining may be understood as any of: calculating, or receiving from the transmitting device 130, or from another network node, e.g., in a distributed node environment, operating in the wireless communications network 100.

It may be understood that to obtain the compression efficiency may comprise to obtain an indication of the compression efficiency.

The compression efficiency may also be referred to herein as a “compression rate”, or “compression ratio”. Therefore, in some examples, obtaining the compression efficiency may be understood determining the compression ratio, as described next.

According to a first group of examples, a node in a wireless network such as the wireless communications network 100 may determine the compression ratio for a set of packets, e.g., the first set of packets. The node, such as the network node 110, may be a RAN node such as an eNB in an LTE network, gNB in an NR network, RNC in an UMTS network, etc. . . . . The node may also be a terminal, or wireless device, e.g., the wireless device 140, such as UE in a 3GPP network. In case the compression ratio is determined by the terminal, e.g., the wireless device 140, the terminal may report the determined ratio to a network node such as the network node 110. Therefore, in some particular embodiments, the transmitting device 130 may be a wireless device 140, and the obtaining 301 of the compression efficiency in this Action 301 may comprise receiving the compression efficiency from the wireless device 140, e.g., via the link 150.

The compression ratio may be determined for packets in a certain bearer and for a certain transmission direction, e.g., for uplink packets. In the description provided below, it may sometimes be used as an example that it may be determined whether compression should be performed for uplink data. However, it may be appreciated that some methods described herein may be applied to evaluate whether compression should be performed for downlink data.

How to Calculate the Compression Ratio

The compression rate may be evaluated by applying a compression algorithm such as the first algorithm, on received data packets, e.g., the first set of packets, and determining a rate at which the data may be compressed, which may for example be expressed as a ratio, e.g., 0.31, ora percentage value or similar. This evaluation may be done considering different criteria such as a limit on amount of memory needed for the compression to be performed, etc. . . . .

In terms of the first algorithm, this may be, as non-limiting examples, a Robust Header Compression (ROHC) algorithm, or a Deflate based Uplink Data Compression (UDC) algorithm. The ROHC algorithm may be understood to be able to compress the header part of data, whereas the UDC algorithm may be understood to be able to compress both the payload and header. The first algorithm may be another type of algorithm.

When it is described that compression is performed, it may be done considering N packets, where N may be 1 or more. If the number N is larger than 1, the compression rate may be determined considering the full N number of calculated compression rates, for example, by taking the average compression rate of N packets. A weighted average may also be possible, where for example higher weight may be given to a later packet, since this may have higher correlation with a potential new packet than would an older one.

Another possibility is to update the compression rate by filtering, where the currently maintained rate is updated with the latest data. For example:

New_calculated_rate=Old rate*0.8+Rate_of_last_data*0.2

When to Determine the Compression Ratio

Below are a set of criteria for when to evaluate the compression ratio.

The compression ratio may be evaluated when the communication starts. This may be done, for example, when a bearer may be set up, that is, when the terminal connects to the network, that is, when the transmitting device 130 may connect to the network node 110. It may be noted that “connecting” to a wireless network such as the wireless communications network 100 may have different steps and may mean different things. For example, an LTE UE may be connecting to the core network to become “attached”, and this may be considered to be the time when the transmitting device 130 may connect to the core network. Another type of connection is the RRC connection, and it may be so that the transmitting device 130 may be connected to the core network, but not having an established RRC connection. It may be appreciated that connecting to the network may also comprise when the RRC connection becomes established. Another possibility is that the RRC connection may be suspended but may become resumed, and when the connection is resumed may also be considered the time when the transmitting device 130 connects to the network.

The compression ratio may be evaluated periodically, for example every X seconds. This may ensure that the evaluation is up-to-date. For example, a first evaluation may have been performed, which may have resulted in a compression rate R1 that did not justify to enable compression. At a later time, another evaluation may be performed, resulting in a compression rate R2 which justifies that compression is enabled. By having a periodic evaluation, it may be ensured that compression is either activated or deactivated based on recent conditions.

Another possibility is that the compression rate calculation may be performed continuously. For example, it then may be performed considering every packet.

Action 302

In some embodiments, the network node 110 may, in this Action 302, obtain a determination of whether or not the compression efficiency of the first algorithm applied to the first information in the first set of packets, exceeds a threshold, e.g., a value.

Determining may be understood as e.g., calculating. By performing this Action 302, the network node 110 may calculate if the compression efficiency is sufficiently option according to a criterion, e.g., to achieve a certain compression gain.

To apply a compression algorithm may be understood as compressing according to the algorithm.

Action 303

In the description provided herein, it has been described how a compression rate may be determined, and it will be described below how this may be used to determine whether or not compression should be activated. However, in some cases it, may be so that more than one compression algorithm may be supported.

In some examples, the actions herein may be performed considering multiple compression algorithms. For example, the compression ratio may be determined for more than one compression algorithm, and if more than one algorithm is found to be suitable for activation by the criteria described herein, one of these algorithms may need to be selected for activation.

Accordingly, in some embodiments, the first compression algorithm may be comprised in a plurality of compression algorithms: In some of such embodiments, the network node 110 may, in this Action 303, select the first compression algorithm from the plurality of compression algorithms. The selecting may be based on at least one of: a) a computational complexity of each compression algorithm in the plurality, and b) the compression efficiency obtained for each compression algorithm in the plurality.

For example, if the compression efficiency of more than one compression algorithm in the plurality is above the threshold, the network node 110 may resort to other criteria to select which compression algorithm is to be used, e.g., the one involving the least computational complexity, or the one having the highest compression efficiency, or a combination of both.

One approach to select algorithm may be to select the algorithm with the highest compression rate.

Similar criteria may be used when considering the computational complexity to perform the selection, e.g., the first compression algorithm with the lowest computational complexity among the plurality of compression algorithms may be selected. However, in some cases, different compression algorithms may have different computational complexity C, and it may be beneficial to consider also the complexity when determining which, if any, algorithm may be applied. Or in general terms, the algorithm may be selected based on a formula considering the compression rates of the candidate algorithms, as well as their associated complexities. The complexities C may be determined considering processing power needed to perform the compression, the amount of memory needed, the delay introduced etc. For example:

A=f(R1,C1,R2,C2, . . . )

It may be appreciated that only certain compression algorithms may be considered. For example, the transmitting device 130, e.g., the UE, may only be capable of certain algorithms, and in that case, only those algorithms may be considered.

Action 304

In this Action 304, the network node 110 determines whether or not to apply the first compression algorithm to the information comprised in a set of packets to be transmitted by the transmitting device 130. The information may be referred to herein as a “second information” and the set of packets may be referred to herein as a “second set of packets”, as will be explained next. The determining this Action 304 may be based on one or more criteria, for example, the determining in this Action 304 is based on at least one of: i) the compression efficiency of the first compression algorithm applied to the first information comprised in the first set of packets, and ii) the computational complexity of the first algorithm, which may be determined as described above.

The information is to be understood as a second information and the set of packets is to be understood as a second set of packets, wherein each of the first set of packets and the second set of packets comprises at least one packet.

In some embodiments, one of the following possibilities may apply. A first possibility is that the first set of packets is the same as the second set of packets. This may be the case, for example, when the network node 110 is the transmitting device 130, and it may evaluate whether it is worth to compress the information in the downlink.

A second possibility is that the first set of packets has previously been transmitted by the transmitting device 130, and is different than the second set of packets. This may be the case, for example, when the transmitting device 130 is the wireless device 140, and the network node 110 may evaluate whether it is worth to compress the information in the uplink, based on the compression efficiency achieved in a previously received set of packets from the wireless device 140.

A third possibility is that the first set of packets has been received by the network node 110 from the transmitting device 130, and is different than the second set of packets. This may be the case, for example, when the transmitting device 130 is the wireless device 140, and the network node 110 may evaluate whether it is worth to compress the information in the uplink, based on the compression efficiency achieved in a previously received set of packets from the wireless device 140.

According to the second and third possibilities, in some particular examples, the network node 110 may perform the determination in this Action 304, based on historical data. That is, the network node 110 may determine whether or not to apply the first compression algorithm to a new set of packets, that is, the second set of packets, to be transmitted, based on the compression efficiency that may have been achieved from applying the first algorithm to a previous set of packets, that is, the first set of packets. For example, if the compression efficiency of the first compression algorithm applied to the first information comprised in the first set of packets achieved a certain gain, e.g., above a value or threshold, the network node 110 may determine to apply the first compression algorithm to the second information comprised in the second set of packets to be transmitted by the transmitting device 130, and vice versa. Other criteria may be applied. Therefore, in some embodiments, the determining 304 of whether or not to apply the first compression algorithm to the second information may be based on the obtained compression efficiency in Action 301. The determining in this Action 304 of whether or not to apply the first compression algorithm to the second information may be further based on the obtained determination in Action 302.

Determining may be understood as any of: calculating, or receiving from another network node, e.g., in a distributed node environment, operating in the wireless communications network 100.

In some embodiments, the determining in this Action 304 may be further based on whether or not the compression efficiency exceeds a threshold. In other words, in one example the decision on whether to activate compression may be done considering the compression rate or compression ratio. For example, if the compression rate is above a threshold e.g., “R”, compression may be activated, while if the compression rate is below the threshold compression may not be activated.

In some examples, even if the compression efficiency of the first algorithm is above the threshold, the network node 110 may still determine that no compression is to be applied, if, for example the computational complexity that may be involved is too high. Therefore, one or more criteria may be considered in the determination performed in this Action 304.

It may be appreciated that while herein it is described how the compression rate may be considered when deciding whether to activate compression or not, it is not precluded whether other metrics may also considered such as capabilities of the terminal, load in the network, etc. . . . . In some embodiments, the determining in this Action 304 may be further based on whether or not the set of packets are encrypted. For example, by Deep packet Inspection (DPI). As explained earlier, if packets are encrypted, it may not be possible to achieve compression gain. Therefore, in some examples, it may be understood that the network node 110 may determine whether or not to apply the first compression algorithm to the information comprised in a set of packets to be transmitted by the transmitting device 130, without necessarily calculating the compression efficiency, but by inspecting the set of packets, on a case by case basis. In such examples, the first information may be the same as the second information, and the first set of packets may be the same as the second set of packets.

In some embodiments, the transmitting device 130 may be the wireless device 140, and the determining in this Action 304 may be further based on at least one of: a) a capability of the wireless device 140, and b) a load of the wireless communications network 100. For example, the capability of the wireless device 140 may indicate which compression algorithms in the plurality may be supported by the wireless device 140.

As for the load of the wireless communications network 100, since the compression may be understood to require extra Central Processing Unit (CPU) processing, in Digital Signal Processing cycles, the compression may be enabled or disabled based on a processing capacity the wireless communications network 100 may have e.g., at a particular time period. For example, when the wireless communications network 100 is not heavily loaded, and thus has processing capacity, it may be beneficial to use compression, and therefore the network node 110 may determine in this Action 304 to apply the first compression algorithm to the information comprised in the set of packets to be transmitted by the transmitting device 130.

In some embodiments, the transmitting device 130 may be the wireless device 140. Hence, the compression may be applied in the uplink.

In other embodiments, the transmitting device 130 may be the network node 110.

Hence, the compression may be applied in the downlink.

It may be noted that, in some examples, Action 303 may performed after Action 304 may have been performed for each compression algorithm in the plurality.

Action 305

In this Action 305, the network node 110 initiates providing, based on a result of the determination of whether or not to apply the first compression algorithm from Action 304, an indication of the result of the determination to the transmitting device 130.

Initiating may be understood as starting the performance of, or as causing or triggering another network node to perform, in this case, the providing. Providing may be any of giving, sending or transmitting.

An indication may be understood herein as any of a variable or a value or code, in e.g., a field or a set of one or more bits in a set of time-frequency resources, as applicable depending on the context.

That the initiating 305 of the providing is based on a result of the determination may be understood as that the indication may be provided e.g., only when the determination is that the first compression algorithm is to be applied. If the determination is that the first compression algorithm is not to be applied, the indication may not be initiated to be provided in some examples. In other examples, the indication may be to refrain from applying the first compression algorithm when the determination is that the first compression algorithm is not to be applied.

The initiating 305 of the providing may be performed via e.g., the link 150.

The indication of the result of the determination in this Action 305 may also be understood as an indication of the decision. The decision of whether an activation or a deactivation of compression should be performed may be done by the network node 110 and may be indicated to the transmitting device 130, e.g., a UE, using Radio Resource Control (RRC) signaling. Therefore, in some embodiments wherein the transmitting device 130 is the wireless device 140, and the indication may be sent by RRC signalling.

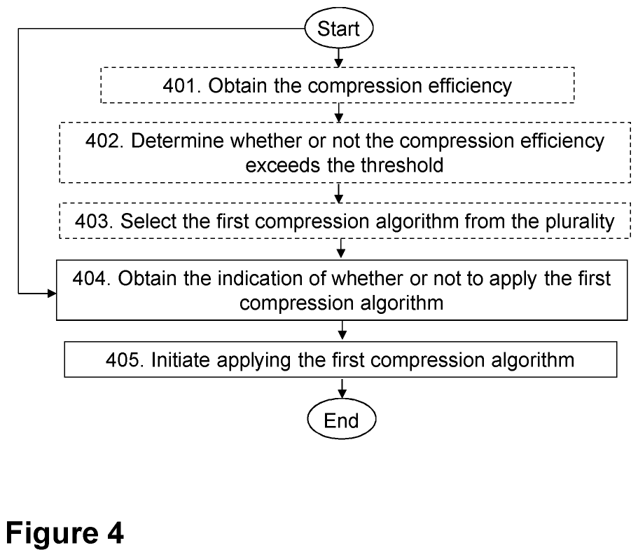

Embodiments of a method performed by the transmitting device 130, will now be described with reference to the flowchart depicted in FIG. 4. The method may be understood to be for managing the compression of the information to be transmitted by the transmitting device 130 in the set of packets. The transmitting device 130 operates in the wireless communications network 100.

In some embodiments all the actions may be performed. In some embodiments, one or more actions may be performed. One or more embodiments may be combined, where applicable. It should be noted that the examples herein are not mutually exclusive. All possible combinations are not described to simplify the description. In FIG. 4, optional actions are indicated with dashed lines. Some actions may be performed in a different order than that shown in FIG. 4.

The detailed description of some of the following corresponds to the same references provided above, in relation to the actions described for the network node 110 and will thus not be repeated here to simplify the description. For example, a packet may be, e.g., an SDU.

Action 401

Similarly to how it was described for the network node 110, in this Action 401, the transmitting device 130 may in this Action 401, obtain the compression efficiency of the first algorithm applied to the first information in the first set of packets.

Obtaining may be understood as any of: calculating, or receiving from another network node, e.g., in a distributed node environment, operating in the wireless communications network 100, or from the network node 110, e.g., via the link 150.

Action 402

Also similarly to how it was described for the network node 110, in this Action 402, the transmitting device 130 may determine, e.g., calculate, whether or not the compression efficiency of the first algorithm applied to the first information in the first set of packets, exceeds the threshold.

Action 403

As described earlier, in some embodiments, the first compression algorithm may be comprised in the plurality of compression algorithms. In such embodiments, in this Action 403, the transmitting device 130 may select the first compression algorithm from the plurality of compression algorithms. The selecting may be based on at least one of: a) the computational complexity of each compression algorithm in the plurality, and b) the compression efficiency obtained for each compression algorithm in the plurality.

The selection may therefore be performed as described for the network node 110.

Action 404

In this Action 404, the transmitting device 130 obtains, from the network node 110 operating in the wireless communications network 100, the indication of the result of the determination of whether or not to apply the first compression algorithm to information comprised in the set of packets to be transmitted by the transmitting device 130. The obtaining 404 of the indication may be based on the one or more criteria. In this Action 404, the obtaining 404 of the indication is based on at least one of: i) the compression efficiency of the first compression algorithm applied to the first information comprised in the first set of packets, and ii) the computational complexity of the first algorithm.

As explained earlier, the information in the previous paragraph may be considered the second information and the set of packets in the previous paragraph may be considered the second set of packets, each of the first set of packets and the second set of packets comprising at least one packet.

Obtaining may comprise any of being provided with, or receiving. In some embodiments, the transmitting device 130 may be the wireless device 140.

In some embodiments wherein the transmitting device 130 may be the wireless device 140, and the indication may be obtained by RRC signalling, e.g., via the link 150.

That the obtaining 404 of the indication is based on the result of the determination may be understood as that the indication may be obtained e.g., only when the determination is that the first compression algorithm is to be applied, e.g., because the compression efficiency is good enough. If the determination is that the first compression algorithm is not to be applied, the indication may not be obtained, in some examples. In other examples, the indication may be to refrain from applying the first compression algorithm when the determination is that the first compression algorithm is not to be applied.

In some embodiments, the obtaining in this Action 404 of the indication may be based on the obtained compression efficiency in Action 401, e.g., in such embodiments wherein Action 401 may have been performed.

In some embodiments, the obtaining 404 of the indication may be further based on whether or not the compression efficiency exceeds the threshold, e.g., as determined in Action 402, in such embodiments wherein Action 402 may have been performed.

In some embodiments, the obtaining 404 of the indication may be further based on whether or not the set of packets are encrypted.

In some embodiments, as described earlier, wherein the transmitting device 130 is a wireless device 140, the obtaining 404 of the indication may be further based on at least one of: a) the capability of the wireless device 140, and b) the load of the wireless communications network 100. This may be understood to mean that the indication is of the result of the determination performed by the network node 110, which in turn may be based on the capability of the wireless device 140, and/or the load of the wireless communications network 100, as described earlier.

As described earlier, in some embodiments, one of the following possibilities may apply: a) the first set of packets is the same as the second set of packets; b) the first set of packets has previously been transmitted by the transmitting device 130, and is different than the second set of packets; and c) the first set of packets has been received by the network node 110 from the transmitting device 130, and is different than the second set of packets.

Also as previously described, in some embodiments, the transmitting device 130 may be the network node 110.

Action 405

In this Action 405, the transmitting device 130 initiates applying the first compression algorithm on the second information, based on the received indication.

Initiating may be understood as starting the performance of, or as causing, enabling or triggering another network node or device to perform, in this case, the application of the compression.

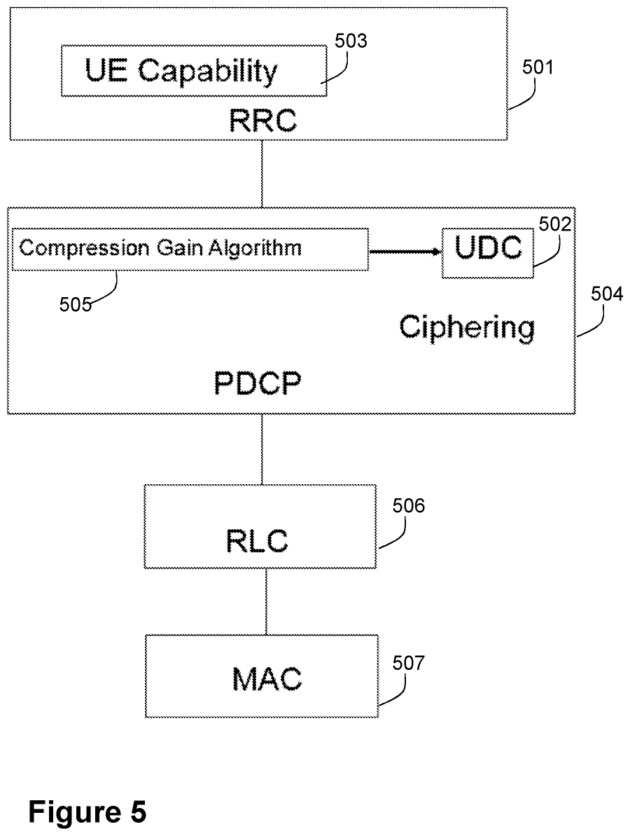

FIG. 5 is a schematic diagram illustrating a potential structure showing placement of a compression algorithm, according to embodiments herein. The structure illustrated in FIG. 5 corresponds to the network node 110. As stated earlier, the determining in Action 304 may be based on the capability of the wireless device 140. Layer 3 (RRC), depicted as element 501 in the Figure, in e.g., the network node 110, may obtain the information on whether or not the UDC algorithm, element 502, is supported by the wireless device 140. This information may be understood to be indicated by capability of the wireless device 130, which may be a UE capability 503. Layer 2, the PDCP layer, which is depicted as element 504 in the Figure, may perform the compression and decompression. As the UDC algorithm is an Uplink Data Compression algorithm, compression may be performed by wireless device 140 as transmitting device 130. Decompression may then be performed by the network node 110. A compression gain evaluation algorithm 505 may be placed in the PDCP entity 504 on both, the wireless device 140 side, and network node 110 side, as depicted in FIG. 5. The compression gain algorithm may be understood as the logic that performs Action 304 in the network node 110. The network node 110 may be able, in accordance with Action 304, to determine whether or not it may be beneficial to enable compression, and which compression algorithm may be applicable. This information may then be fed to a compression entity such as the UDC 502 in the PDCP layer 504, to enable compression. The determining in Action 304 may also comprise performing Deep Packet Inspection (DPI) to verify if the packets are encrypted or not, and based on that, determining whether to compress a packet or not. The RLC layer 506 and the MAC layer 507 may provide services to the upper layers, such as with in order delivery and Hybrid Automatic Repeat reQuest (HARQ) mechanism, respectively. It may be noted that the compression gain algorithm may also be placed in the wireless device 140 as transmitting device 130. When the network node 110 has enabled the UDC, the transmitting device 130 may then judge whether to compress a packet or not based upon its compression gain algorithm.

One advantage of embodiments herein is that the methods described enable to avoid unnecessary signalling between the transmitting device 130 and the network node 110, e.g., between UE and eNB, with regards to compression of information, e.g., data. For example, as described earlier, signalling of RRC Reconfiguration bits comprising UDC configurations may be avoided.

A further advantage of embodiments herein is that the methods described enable to avoid unnecessary attempts to compress a packet for which compression gain may be determined to be insignificant and/or too low compared to the added complexity and processing load that may be required for performing the compression.

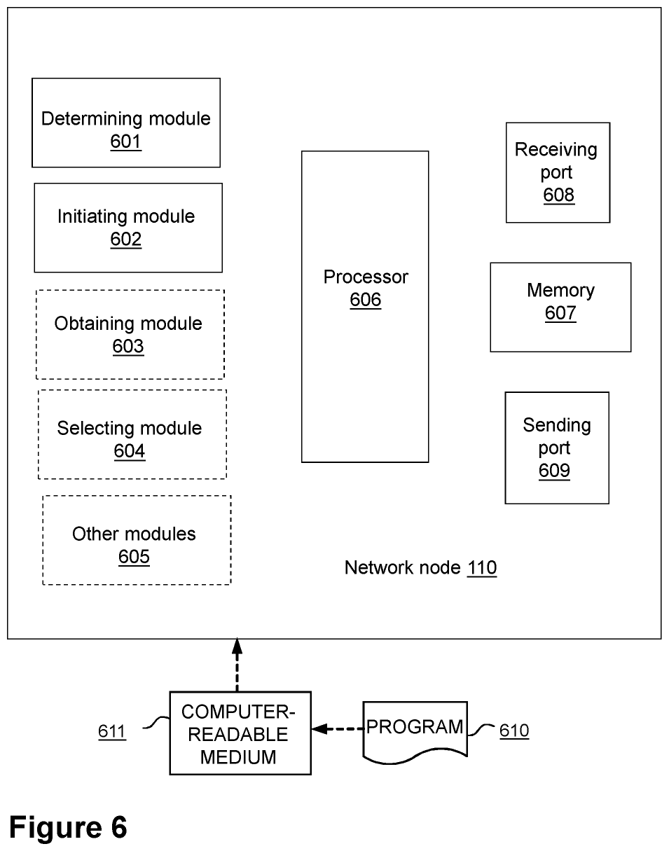

To perform the method actions described above in relation to FIG. 3 and/or FIG. 5, the network node 110 may comprise the following arrangement depicted in FIG. 6. The network node 110 is configured to manage the compression of the information configured to be transmitted by the transmitting device 130 in the set of packets. The network node 110 and the transmitting device 130 are configured to operate in the wireless communications network 100.

The detailed description of some of the following corresponds to the same references provided above, in relation to the actions described for the network node 110, and will thus not be repeated here. For example, in some embodiments, the transmitting device 130 may be the network node 110.

In FIG. 6, optional modules are indicated with dashed boxes.

The network node 110 is configured to, e.g. by means of a determining module 601 within the network node 110 configured to, determine whether or not to apply the first compression algorithm to the information configured to be comprised in the set of packets configured to be transmitted by the transmitting device 130. To determine is configured to be based on at least one of: i) the compression efficiency of the first compression algorithm configured to be applied to the first information configured to be comprised in the first set of packets, and ii) the a computational complexity of the first algorithm. The information is the second information and the set of packets is the second set of packets. Each of the first set of packets and the second set of packets are configured to comprise at least one packet. The determining module 601 may be a processor 606 of the network node 110, or an application running on such processor.

In some embodiments, to determine may be further configured to be based on whether or not the compression efficiency exceeds the threshold.

To determine may be further configured to be based on whether or not the set of packets are encrypted.

In some embodiments, wherein the transmitting device 130 may be a wireless device 140, to determine may be further configured to be based on at least one of: a) the capability of the wireless device 140, and b) the load of the wireless communications network 100.

The network node 110 is also configured to, e.g. by means of an initiating module 602 within the network node 110 configured to, initiate providing, based on the result of the determination of whether or not to apply the first compression algorithm, the indication of the result of the determination to the transmitting device 130. The initiating module 602 may be the processor 606 of the network node 110, or an application running on such processor.

The network node 110 may be further configured to, e.g. by means of an obtaining module 603 within the network node 110 configured to, obtain the compression efficiency of the first algorithm configured to be applied to the first information in the first set of packets. To determine whether or not to apply the first compression algorithm to the second information may be configured to be based on the compression efficiency configured to be obtained. The obtaining module 603 may be the processor 606 of the network node 110, or an application running on such processor.

In some embodiments, the network node 110 may be configured, e.g. by means of obtaining module 603 within the network node 110 configured to, obtain the determination of whether or not the compression efficiency of the first algorithm configured to be applied to the first information in the first set of packets, exceeds the threshold. To determine whether or not to apply the first compression algorithm to the second information may be further configured to be based on the determination configured to be obtained.

In some embodiments wherein the first compression algorithm may be configured to be comprised in the plurality of compression algorithms, the network node 110 may, be configured to, e.g. by means of a selecting module 604 within the network node 110 configured to, select the first compression algorithm from the plurality of compression algorithms. To select may be configured to be based on at least one of: a) the computational complexity of each compression algorithm in the plurality, and b) the compression efficiency configured to be obtained for each compression algorithm in the plurality. The selecting module 604 may be the processor 606 of the network node 110, or an application running on such processor.

Other modules 605 may be comprised in the network node 110.

The embodiments herein may be implemented through one or more processors, such as a processor 606 in the network node 110 depicted in FIG. 6, together with computer program code for performing the functions and actions of the embodiments herein. The program code mentioned above may also be provided as a computer program product, for instance in the form of a data carrier carrying computer program code for performing the embodiments herein when being loaded into the in the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 607 comprising one or more memory units. The memory 607 is arranged to be used to store obtained information, store data, configurations, schedulings, and applications etc. to perform the methods herein when being executed in the network node 110.

In some embodiments, the network node 110 may receive information from, e.g., the transmitting device 130, through a receiving port 608. In some embodiments, the receiving port 608 may be, for example, connected to one or more antennas in network node 110. In other embodiments, the network node 110 may receive information from another structure in the wireless communications network 100 through the receiving port 608. Since the receiving port 608 may be in communication with the processor 606, the receiving port 608 may then send the received information to the processor 606. The receiving port 608 may also be configured to receive other information.

The processor 606 in the network node 110 may be further configured to transmit or send information to e.g., the transmitting device 130, through a sending port 609, which may be in communication with the processor 606, and the memory 607.

Those skilled in the art will also appreciate that the determining module 601, the initiating module 602, the obtaining module 603, the selecting module 604 and the other modules 605 described above may refer to a combination of analog and digital modules, and/or one or more processors configured with software and/or firmware, e.g., stored in memory, that, when executed by the one or more processors such as the processor 606, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 601-605 described above may be implemented as one or more applications running on one or more processors such as the processor 606.

Thus, the methods according to the embodiments described herein for the network node 110 may be respectively implemented by means of a computer program 610 product, comprising instructions, i.e., software code portions, which, when executed on at least one processor 606, cause the at least one processor 606 to carry out the actions described herein, as performed by the network node 110. The computer program 610 product may be stored on a computer-readable storage medium 611. The computer-readable storage medium 611, having stored thereon the computer program 610, may comprise instructions which, when executed on at least one processor 606, cause the at least one processor 606 to carry out the actions described herein, as performed by the network node 110. In some embodiments, the computer-readable storage medium 611 may be a non-transitory computer-readable storage medium, such as a CD ROM disc, a memory stick, or stored in the cloud space. In other embodiments, the computer program 610 product may be stored on a carrier containing the computer program, wherein the carrier is one of an electronic signal, optical signal, radio signal, or the computer-readable storage medium 611, as described above.

Hence, embodiments herein also relate to the network node 110 operative to manage the compression of the information configured to be transmitted by the transmitting device 130 in the set of packets. The network node 110 and the transmitting device 130 are operative to operate in the wireless communications network 100. The network node 110 may comprise a processing circuitry and the memory 607, said memory 607 containing instructions executable by said processing circuitry, whereby the network node 110 is further operative to perform the actions described herein in relation to the network node 110, e.g., in FIG. 3 and/or FIG. 5. The processing circuitry may be understood to correspond to the processor 606.

The network node 110 may comprise an interface unit to facilitate communications between the network node 110 and other nodes or devices, e.g., the transmitting device 130, or any of the other nodes. In some particular examples, the interface may, for example, include a transceiver configured to transmit and receive radio signals over an air interface in accordance with a suitable standard.

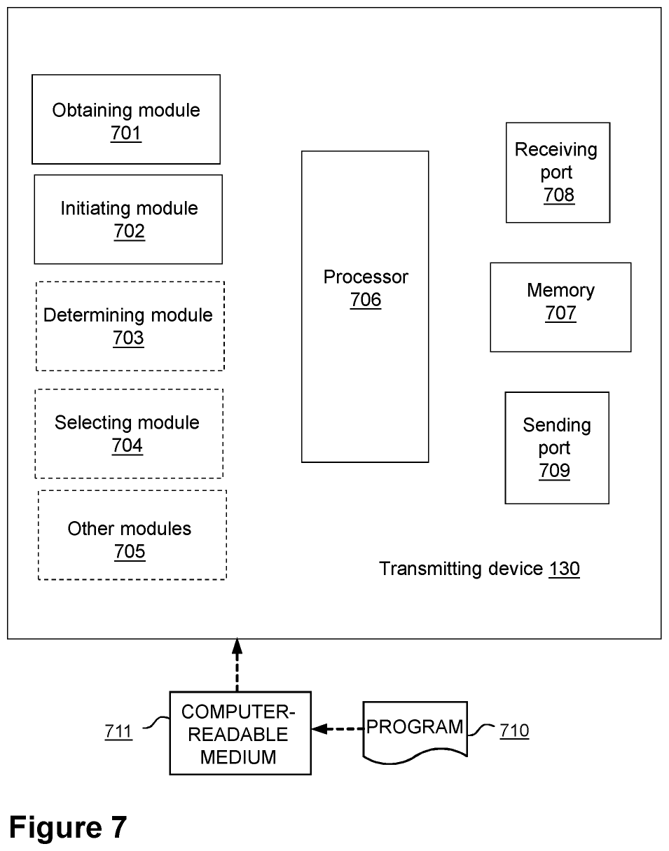

To perform the method actions described above in relation to FIG. 4, the transmitting device 130 may comprise the following arrangement depicted in FIG. 7. The transmitting device 130 is configured to manage the compression of the information configured to be transmitted by the transmitting device 130 in the set of packets. The transmitting device 130 is configured to operate in the wireless communications network 100.

The detailed description of some of the following corresponds to the same references provided above, in relation to the actions described for the transmitting device 130, and will thus not be repeated here. For example, in some embodiments, the transmitting device 130 may be the network node 110.

In FIG. 7, optional modules are indicated with dashed boxes.

The transmitting device 130 is configured to, e.g., by means of an obtaining module 701 within the transmitting device 130 configured to, obtain, from the network node 110 configured to operate in the wireless communications network 100, the indication of the result of the determination of whether or not to apply the first compression algorithm to the information comprised in the set of packets configured to be transmitted by the transmitting device 130. To obtain the indication is configured to be based on at least one of: i) the compression efficiency of the first compression algorithm configured to be applied to the first information configured to be comprised in the first set of packets, and ii) the computational complexity of the first algorithm. The information is the second information and the set of packets is the second set of packets. Each of the first set of packets and the second set of packets are configured to comprise at least one packet. The obtaining module 701 may be a processor 706 of the transmitting device 130, or an application running on such processor.

In some embodiments, to obtain the indication may be further configured to be based on whether or not the compression efficiency exceeds the threshold.

In some embodiments, to obtain the indication may be further configured to be based on whether or not the set of packets are encrypted.

In some embodiments, the transmitting device 130 may be the wireless device 140, and to obtain the indication may be further configured to be based on at least one of: a) the capability of the wireless device 140, and b) the load of the wireless communications network 100.

The transmitting device 130 is further configured to, e.g. by means of an initiating module 702 within the transmitting device 130 configured, to initiate applying the first compression algorithm on the second information, based on the indication configured to be received. The initiating module 702 may be the processor 706 of the transmitting device 130, or an application running on such processor.

In some embodiments, the transmitting device 130 may be configured to, e.g., by means of the obtaining module 701 within the transmitting device 130 configured to, obtain the compression efficiency of the first algorithm configured to be applied to the first information in the first set of packets. To obtain the indication may be configured to be based on the compression efficiency configured to be obtained.

In some embodiments, the transmitting device 130 may be configured to, by means of a determining module 703 within the transmitting device 130 configured to, determine whether or not the compression efficiency of the first algorithm configured to be applied to the first information in the first set of packets, exceeds the threshold. To obtain the indication may be further configured to be based on whether or not the compression efficiency exceeds the threshold. The determining module 703 may be the processor 706 of the transmitting device 130, or an application running on such processor.

In some embodiments wherein the first compression algorithm may be configured to be comprised in the plurality of compression algorithms, the transmitting device 130 may be configured to, by means of a selecting module 704 within the transmitting device 130 configured to, select the first compression algorithm from the plurality of compression algorithms. To select may be configured to be based on at least one of: a) the computational complexity of each compression algorithm in the plurality, and b) the compression efficiency configured to be obtained for each compression algorithm in the plurality. The selecting module 704 may be the 706 of the transmitting device 130, or an application running on such processor.

Other modules 705 may be comprised in the transmitting device 130.

The embodiments herein may be implemented through one or more processors, such as a processor 706 in the transmitting device 130 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the transmitting device 130. One such carrier may be in the form of a CD ROM disc. It is however feasible with other data carriers such as a memory stick. The computer program code may furthermore be provided as pure program code on a server and downloaded to the transmitting device 130.

The transmitting device 130 may further comprise a memory 707 comprising one or more memory units. The memory 707 is arranged to be used to store obtained information, store data, configurations, schedulings, and applications etc. to perform the methods herein when being executed in the transmitting device 130.

In some embodiments, the transmitting device 130 may receive information from the network node 110 and/or the wireless device 140, through a receiving port 708. In some embodiments, the receiving port 708 may be, for example, connected to one or more antennas in transmitting device 130. In other embodiments, the transmitting device 130 may receive information from another structure in the wireless communications network 100 through the receiving port 708. Since the receiving port 708 may be in communication with the processor 706, the receiving port 708 may then send the received information to the processor 706. The receiving port 708 may also be configured to receive other information.

The processor 706 in the transmitting device 130 may be further configured to transmit or send information to e.g., the network node 110, and/or the wireless device 140, through a sending port 709, which may be in communication with the processor 706, and the memory 707.

Those skilled in the art will also appreciate that the obtaining module 701, the initiating module 702, the determining module 703, the selecting module 704, and the other modules 705 described above may refer to a combination of analog and digital modules, and/or one or more processors configured with software and/or firmware, e.g., stored in memory, that, when executed by the one or more processors such as the processor 706, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 701-705 described above may be implemented as one or more applications running on one or more processors such as the processor 706.

Thus, the methods according to the embodiments described herein for the transmitting device 130 may be respectively implemented by means of a computer program 710 product, comprising instructions, i.e., software code portions, which, when executed on at least one processor 706, cause the at least one processor 706 to carry out the actions described herein, as performed by the transmitting device 130. The computer program 710 product may be stored on a computer-readable storage medium 711. The computer-readable storage medium 711, having stored thereon the computer program 710, may comprise instructions which, when executed on at least one processor 706, cause the at least one processor 706 to carry out the actions described herein, as performed by the transmitting device 130. In some embodiments, the computer-readable storage medium 711 may be a non-transitory computer-readable storage medium, such as a CD ROM disc, a memory stick, or stored in the cloud space. In other embodiments, the computer program 710 product may be stored on a carrier containing the computer program, wherein the carrier is one of an electronic signal, optical signal, radio signal, or the computer-readable storage medium 711, as described above.

Hence, embodiments herein also relate to the transmitting device 130 operative to manage the compression of the information configured to be transmitted by the transmitting device 130 in the set of packets. The transmitting device 130 is further operative to operate in the wireless communications network 100. The transmitting device 130 may comprise a processing circuitry and the memory 707, said memory 707 containing instructions executable by said processing circuitry, whereby the transmitting device 130 is further operative to perform the actions described herein in relation to the transmitting device 130, e.g., in FIG. 4. The processing circuitry may be understood to correspond to the processor 706.

The transmitting device 130 may comprise an interface unit to facilitate communications between the transmitting device 130 and other nodes or devices, e.g., the network node 110, the wireless device 140, or any of the other nodes or devices. In some particular examples, the interface may, for example, include a transceiver configured to transmit and receive radio signals over an air interface in accordance with a suitable standard.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

The term module may be understood herein as being equivalent to the term unit.

The term processor may be understood to refer to a hardware component, e.g., a processing circuit.

1. A method performed by a network node, the method being for managing compression of information to be transmitted by a transmitting device in a set of packets, the network node and the transmitting device operating in a wireless communications network, the method comprising:
determining whether or not to apply a first compression algorithm to information comprised in a set of packets to be transmitted by the transmitting device, the determining being based on at least one of:
i. a compression efficiency of the first compression algorithm applied to a first information comprised in a first set of packets, the information being a second information and the set of packets being a second set of packets, each of the first set of packets and the second set of packets comprising at least one packet, and
ii. a computational complexity of the first algorithm, and
initiating providing, based on a result of the determination of whether or not to apply the first compression algorithm, an indication of the result of the determination to the transmitting device.

2. The method according to claim 1, wherein the determining is further based on whether or not the compression efficiency exceeds a threshold.

3. The method according to claim 1, wherein the determining is further based on whether or not the set of packets are encrypted.

4. The method according to claim 1, further comprising:
obtaining the compression efficiency of the first algorithm applied to the first information in the first set of packets, wherein the determining of whether or not to apply the first compression algorithm to the second information is based on the obtained compression efficiency.

5. (canceled)

6. The method according to claim 1, wherein the first compression algorithm is comprised in a plurality of compression algorithms, and wherein the method further comprises:
selecting the first compression algorithm from the plurality of compression algorithms, the selecting being based on at least one of:
a) a computational complexity of each compression algorithm in the plurality, and
b) the compression efficiency obtained for each compression algorithm in the plurality.

7.-8. (canceled)

9. The method according to claim 1, wherein the transmitting device is a wireless device, and wherein the determining is further based on at least one of:
a) a capability of the wireless device, and
b) a load of the wireless communications network.

10. (canceled)

11. The method according to claim 1, wherein one of:
a. the first set of packets is the same as the second set of packets;
b. the first set of packets has previously been transmitted by the transmitting device, and is different than the second set of packets; and
c. the first set of packets has been received by the network node from the transmitting device, and is different than the second set of packets.

12. A method performed by a transmitting device, the method being for managing compression of information to be transmitted by the transmitting device in a set of packets, the transmitting device operating in a wireless communications network, the method comprising:
obtaining, from a network node operating in the wireless communications network, an indication of a result of a determination of whether or not to apply a first compression algorithm to information comprised in a set of packets to be transmitted by the transmitting device, the obtaining of the indication being based on at least one of:
i. a compression efficiency of the first compression algorithm applied to a first information comprised in a first set of packets, the information being a second information and the set of packets being a second set of packets, each of the first set of packets and the second set of packets comprising at least one packet, and
ii. a computational complexity of the first algorithm, and
initiating applying the first compression algorithm on the second information, based on the received indication.

13. The method according to claim 12, wherein the obtaining of the indication is further based on whether or not the compression efficiency exceeds a threshold.

14. The method according to claim 12, wherein the obtaining of the indication is further based on whether or not the set of packets are encrypted.

15. The method according to claim 12, further comprising:
obtaining the compression efficiency of the first algorithm applied to the first information in the first set of packets, wherein the obtaining of the indication is based on the obtained compression efficiency.

16. (canceled)

17. The method according to claim 12, wherein the first compression algorithm is comprised in a plurality of compression algorithms, and wherein the method further comprises:
selecting the first compression algorithm from the plurality of compression algorithms, the selecting being based on at least one of:
a) a computational complexity of each compression algorithm in the plurality, and
b) the compression efficiency obtained for each compression algorithm in the plurality.

18. The method according to claim 12, wherein the transmitting device is a wireless device, and wherein the indication is obtained by Radio Resource Control signalling.

19. The method according to claim 12, wherein the transmitting device is a wireless device, and wherein the obtaining of the indication is further based on at least one of:
a) a capability of the wireless device, and
b) a load of the wireless communications network.

20. (canceled)

21. The method according to claim 12, wherein one of:
a. the first set of packets is the same as the second set of packets;
b. the first set of packets has previously been transmitted by the transmitting device, and is different than the second set of packets; and
c. the first set of packets has been received by the network node from the transmitting device, and is different than the second set of packets.

22. A network node configured to manage compression of information configured to be transmitted by a transmitting device in a set of packets, the network node and the transmitting device being configured to operate in a wireless communications network, the network node being further configured to:
determine whether or not to apply a first compression algorithm to information configured to be comprised in a set of packets configured to be transmitted by the transmitting device, wherein to determine is configured to be based on at least one of:
i. a compression efficiency of the first compression algorithm configured to be applied to a first information configured to be comprised in a first set of packets, the information being a second information and the set of packets being a second set of packets, each of the first set of packets and the second set of packets being configured to comprise at least one packet, and
ii. a computational complexity of the first algorithm, and
initiate providing, based on a result of the determination of whether or not to apply the first compression algorithm, an indication of the result of the determination to the transmitting device.

23. The network node according to claim 22, wherein to determine is further configured to be based on whether or not the compression efficiency exceeds a threshold.

24. The network node according to claim 22, wherein to determine is further configured to be based on whether or not the set of packets are encrypted.

25. The network node according to claim 22, being further configured to:
obtain the compression efficiency of the first algorithm configured to be applied to the first information in the first set of packets, wherein to determine whether or not to apply the first compression algorithm to the second information is configured to be based on the compression efficiency configured to be obtained.

26. (canceled)

27. The network node according to claim 22, wherein the first compression algorithm is configured to be comprised in a plurality of compression algorithms, and wherein the network node is further configured to:
select the first compression algorithm from the plurality of compression algorithms, wherein to select is configured to be based on at least one of:
a) a computational complexity of each compression algorithm in the plurality, and
b) the compression efficiency configured to be obtained for each compression algorithm in the plurality.

28. (canceled)

29. A transmitting device configured to manage compression of information configured to be transmitted by the transmitting device in a set of packets, the transmitting device being configured to operate in a wireless communications network, the transmitting device being further configured to:
obtain, from a network node configured to operate in the wireless communications network, an indication of a result of a determination of whether or not to apply a first compression algorithm to information comprised in a set of packets configured to be transmitted by the transmitting device, wherein to obtain the indication is configured to be based on at least one of:
i. a compression efficiency of the first compression algorithm configured to be applied to a first information configured to be comprised in a first set of packets, the information being a second information and the set of packets being a second set of packets, each of the first set of packets and the second set of packets being configured to comprise at least one packet, and
ii. a computational complexity of the first algorithm, and
initiate applying the first compression algorithm on the second information, based on the indication configured to be received.

30. The transmitting device according to claim 29, wherein to obtain the indication is further configured to be based on whether or not the compression efficiency exceeds a threshold.

31. The transmitting device according to claim 29, wherein to obtain the indication is further configured to be based on whether or not the set of packets are encrypted.

32. (canceled)

33. The transmitting device according to claim 29, being further configured to:
determine whether or not the compression efficiency of the first algorithm configured to be applied to the first information in the first set of packets, exceeds the threshold, wherein to obtain the indication is further configured to be based on whether or not the compression efficiency exceeds the threshold.

34. (canceled)

35. The transmitting device according to claim 29, wherein the transmitting device is a wireless device, and wherein to obtain the indication is further configured to be based on at least one of:
a) a capability of the wireless device, and
b) a load of the wireless communications network.
